(19) United States
(12) Patent Application Publication
(10) Pub. No.: US 2014/0274043 A1
(43) Pub. Date: Sep. 18, 2014

(54) ACCESS POINT SELECTION FOR ASSISTANCE DATA GENERATION

(71) Applicant: QUALCOMM Incorporated, San Diego, CA (US)

(72) Inventors: Saumitra Mohan DAS, Santa Clara, CA (US); Faraz Mohammad MIRZAEI, San Jose, CA (US); Vinay SRIDHARA, Sunnyvale, CA (US)

(21) Appl. No.: 13/834,894

(22) Filed: Mar. 15, 2013

(51) Int. Cl. H04W 48/20

(52) U.S. Cl. CPC H04W 48/20
USPC 455/434

(57) ABSTRACT

Methods, systems, computer-readable media, and apparatuses selecting access points and generating assistance data for access points is provided. In one embodiment a plurality of access points in a first area are identified, a location assistance quality value with each access point of the plurality of access points is associated with each access point, and a subset of the plurality of access points is selected based on the location assistance quality value of each access point of the plurality of access points. Assistance data is then generated for the selected access points.

### BACKGROUND

Aspects of the disclosure relate to the use of wireless network based positioning systems. In particular, aspects relate to access point selection for assistance data generation. This may particularly apply to areas in which a total number of access points may be large enough to cause issues with assistance systems.

Mobile electronic devices with the capability to provide information regarding the location of the device and the device's user, along with associated wireless network based positioning systems are becoming more and more widespread in today's society. For example, people use cellular phones, smart phones, personal digital assistants, laptop computers, pagers, tablet computers, and other such devices to send and receive data wirelessly from countless locations via network access points. Advancements in wireless communication technology have aided in the use of networks to create and use location information created via interaction between the wireless networks and the mobile devices. Location assistance services may use such information to provide assistance to mobile device users.

In certain public environments, access points may be made available to users of mobile electronic devices. Such access points may connect with local area networks which further connect to additional networks to enable a wide variety of services to users of mobile devices, including Internet connectivity and location assistance services. In certain environments and location systems, assistance data may be provided to a user's devices to assist in locating and using these access points.

In some environments, the total number of access points may overwhelm the ability of certain devices and systems to function. As the prevalence of users with mobile electronic devices operating in an area at any given time increases, the number of access points available to provide network services increases, and the number of areas in which wireless network based location services are available also increases, improved systems may be designed which provide benefits and functionality not previously known based on the widespread presence and usage of mobile devices and networks with location services. Deployments of wireless network based positioning systems are thus creating new possibilities and complexities in providing services to users of mobile devices.

### BRIEF SUMMARY

Certain embodiments are described that relate to access point selection for assistance data generation. For example, one embodiment described herein may be a method comprising: identifying, using a computing device, a plurality of access points in a first area using an identifier for each access point of the plurality of access points; associating a location assistance quality value with each access point of the plurality of access points; selecting a subset of the plurality of access points based on the location assistance quality value of each access point of the plurality of access points; and generating assistance data including identifiers for the subset of the plurality of access points.

Another embodiment of such a method may further comprise communicating the assistance data for the subset of the plurality of access points to a mobile device in response to a request for location services. Another embodiment of such a method may further function where the location assistance quality value comprises a first quality value based on previously determined vendor priority. Another embodiment of such a method may further function where the location assistance quality value comprises a second quality value based on a number of access points associated with a particular vendor.

Another embodiment of such a method may further function where the location assistance quality value comprises a value associated with a mobile side chip. Another embodiment of such a method may further function where the location assistance quality value comprises a horizontal dilution of precision (HDOP) value. Another embodiment of such a method may further function where the location assistance quality value comprises a received signal strength indication (RSSI) heat map quality value.

Another embodiment of such a method may further comprise calculating the location assistance quality value using a name quality value, a name quantity value, and a mobile quality value.

Another embodiment of such a method may further function where calculating the location assistance quality value further comprises: determining a first group of access points from the name quality value, the name quantity value, and the mobile quality value of each of the plurality of access points to identify the first group of access points; receiving HDOP information and RSSI heat map information for each access point of the first group of access points; calculating a signal quality value from the HDOP information and the RSSI heat map information; and further calculating the location assistance quality value using the signal quality value.

Another embodiment of such a method may further function where selecting the subset of the plurality of access points based on the location assistance quality value of each access point of the plurality of access points comprises eliminating access points identified as having mobile chipsets from the subset of the plurality of access points.

Another embodiment of such a method may further comprise communicating the assistance data to a location assistance server. Another embodiment of such a method may further function where identifying the plurality of access points in the first area using the identifier for each access point of the plurality of access points comprises; receiving, using a mobile device comprising the computing device at a first location within the first area, a first set of signals from at least a first portion of the plurality of access points; receiving, using the mobile device at a second location within the first area, a second set of signals from at least a second portion of the plurality of access points; and associating a first set of identifiers corresponding to the identifier for each access point of the plurality of access points with each access point of the first and second portions of the plurality of access points.

Another embodiment of such a method may further function where identifying the plurality of access points in the first area using the identifier for each access point of the plurality of access points comprises: identifying a plurality of media access controls (MACs) associated with a single access point; merging the plurality of MACs associated with the single access point into a virtual access point; and assigning a first identifier to the virtual access point.

Another embodiment of such a method may further function where associating the location assistance quality value with each access point of the plurality of access points comprises associating a first location assistance quality value with the virtual access point.

Another potential embodiment may be a mobile device comprising: a processor; an antenna coupled to the processor; and a computer readable storage device coupled to the processor; where the antenna receives signals from a plurality of access points and communicates the signals to the processor which identifies the plurality of access points in a first area using an identifier for each access point of the plurality of access points; and where the processor associates a location assistance quality value with each access point of the plurality of access points, selects a subset of the plurality of access points based on the location assistance quality value of each access point of the plurality of access points and generates assistance data including identifiers for the subset of the plurality of access points.

Another embodiment of such a mobile device may further function where the processor further communicates the assistance data to a location assistance server via the antenna. Another embodiment of such a mobile device may further function where the processor further calculates RSSI map data using the signals from the plurality of access points, and wherein the location assistance quality value of each access point of the plurality of access points is based on the RSSI map data.

Another embodiment may be a non-transitory computer readable storage medium comprising a computer program product of computer readable instructions for performing a method of providing assistance data, the method comprising: receiving, at a computing device, at least one signal associated with a plurality of access points in a first area; identifying the plurality of access points using an identifier for each access point of the plurality of access points; associating a location assistance quality value with the identifier for each access point of the plurality of access points; selecting a subset of the plurality of access points based on the location assistance quality value of each access point of the plurality of access points; and generating the assistance data including identifiers for the subset of the plurality of access points.

In further embodiments of such a non-transitory computer readable storage medium the computing device comprises a location assistance server, and the at least one signal is received from a first mobile device in communication with at least a portion of the plurality of access points.

In further embodiments of such a non-transitory computer readable storage medium the computing device the method further comprises: receiving, from a second mobile device, a request for the assistance data associated with the first area; and communicating from the computing device to the second mobile device, the assistance data including the identifiers for the subset of the plurality of access points.

An additional embodiment may be a computing device comprising: means for identifying a plurality of access points in a first area using an identifier for each access point of the plurality of access points; means for associating a location assistance quality value with each access point of the plurality of access points; means for selecting a subset of the plurality of access points based on the location assistance quality value of each access point of the plurality of access points; and means for generating assistance data including identifiers for the subset of the plurality of access points.

Additional embodiments of such a computing device may further comprise: means for communicating the assistance data for the subset of the plurality of access points to a mobile device in response to a request for location services or means for calculating the location assistance quality value using a name quality value, a name quantity value, and a mobile quality value.

Additional embodiments of such a computing device may further comprise: means for determining a first group of access points from the name quality value, the name quantity value, and the mobile quality value of each of the plurality of access points to identify the first group of access points; means for receiving horizontal dilution of precision (HDOP) information and received signal strength indication (RSSI) heat map information for each access point of the first group of access points; means for calculating a signal quality value from the HDOP information and the RSSI heat map information; and means for calculating the location assistance quality value using the signal quality value.

While various specific embodiments are described, a person of ordinary skill in the art will understand that elements, steps, and components of the various embodiments may be arranged in alternative structures while remaining within the scope of the description. Also, additional embodiments will be apparent given the description herein, and thus the description is not referring only to the specifically described embodiments, but to any embodiment capable of the function or structure described herein.

### BRIEF DESCRIPTION OF THE DRAWINGS

Aspects of the disclosure are illustrated by way of example. In the accompanying figures, like reference numbers indicate similar elements, and:

FIG. 1 illustrates a simplified diagram of a system for use with one or more embodiments;

FIG. 2 illustrates one aspect of an environment that may function with aspects of one or more embodiments;

FIG. 3a illustrates one aspect of an environment that may function with aspects of one or more embodiments;

FIG. 3b illustrates one aspect of an environment that may function with aspects of one or more embodiments;

FIG. 4 illustrates aspects of a method that may incorporate one or more embodiments;

FIG. 5 illustrates aspects of a method that may incorporate one or more embodiments;

FIG. 6 illustrates an example of a computing system in which one or more embodiments may be implemented; and

FIG. 7 illustrates an example of a mobile computing device that may function in accordance with one or more embodiments.

### DETAILED DESCRIPTION

Several illustrative embodiments will now be described with respect to the accompanying drawings. While particular embodiments in which one or more aspects of the disclosure may be implemented are described below, other embodiments not specifically detailed will be apparent from the description. Such additional embodiments may be used and various modifications may be made without departing from the scope of the disclosure or the spirit of the appended claims.

In certain embodiments, indoor positioning systems may use knowledge of access point (AP) locations in order to provide assistance data such as direction information to a mobile device. In certain embodiments this knowledge may be used along with a map of the area for which location services are provided. In areas with location services, APs for wireless communication may be used not only as data APs, but also as location references for services which enable location and direction services. Mobile devices can perform ranging measurements with these reference APs to obtain the device location. This is especially true for indoor locations where other location services may be obstructed, but where APs may be specifically disposed for indoor use.

Additionally, associated heat map data which contains expected signal strength or round trip time information for an individual AP at a multitude of points on the map provides a user with assistance data to enable location services. As it becomes more popular for businesses to provide APs for use by potential customers and employees, location services may be degraded by intermittent, low quality, or excessive numbers of access points that may overlap with other access points. For example, large numbers of access points involve greater amounts of time to create a heatmap using either interpolated measurements or propagation models. Large numbers of access points also generate larger amounts of location assistance data that may slow a device's ability to quickly process location assistance data for a particular place or area and increase the data costs (delay and money) of providing the assistance data to the mobile. Filtering access points for use with location services may thus provide more stable and higher quality location services. Filtering access points may also enable certain devices to use assistance data with location services that might otherwise be overwhelmed or unable to function without this filtering. Filtering access points may also reduce the network costs of obtaining assistance data.

Certain embodiments of the present innovations are directed to access point selection for assistance data generation. For example, in one embodiment, a user may have a relationship with an assistance server whereby the user's device receives assistance data from an assistance server. This assistance data may include details for access points in a particular environment which includes their locations and/or their heatmaps of different signal characteristics such as signal strength and round trip time. Some environments may include a large number of APs so that from specific locations inside the area, a mobile device may have an option to connect and receive data from multiple different APs. Depending on the type of information provided for each AP and the number of APs, assistance data for every AP in an area may overwhelm the bandwidth and storage of a mobile device as well as consume resources in the server cloud platform that serves the assistance data. In order to more efficiently provide the most useful information to a user device, a subset of the total number of access points in the environment may be identified as the highest value access points, and only information for that subset of APs may be created and provided from the assistance server to the user device as part of assistance data. Such a selection may not only reduce resource use, but may also provide an improved user experience and reduce resources used in creating and delivering assistance data. Finally, depending on the capabilities of the requesting mobile device a different subset of APs may potentially be selected. For example, if the mobile device does not support RTT ranging, the subset of APs chosen should not be based on their RTT measurement quality.

This will impact not only the use of location services by a user, but deployment time and expense during creation and implementation of location services for an area. By filtering APs before certain types of assistance data is gathered, costs may be reduced, time may be saved, and data may be generated more efficiently during deployment of location services.

As discussed herein, “assistance data” may refer to any data provided to a user to assist the user. Specific examples of assistance data may be data that identifies the location of a user device, or data that provides directions to a user. Assistance data may additionally include identifying information for access points available for use by a user device. This information may further include maps of received signal strength (RSSI) for individual access points, horizontal dilution of precision information for particular areas around an AP, or any other such information.

As described herein, the term “user” refers to any person that interacts with a wireless network based system that provides assistance data. Such users may be within an area that a wireless network based service provides assistance data for, or may be outside the system. Such persons may have mobile devices associated with them that interact electronically with the assistance system.

As used herein, “access point”, or AP, refers to a device connected as part of a wireless local area network (WLAN) that may be accessed by a user's mobile device. Such a network may provide wireless access to a broader network using a particular wireless networking protocol such as an IEEE 802.11 protocol, Bluetooth, or any other wireless communication method.

As used herein, “mobile device” refers to any mobile electronic computing device capable of communicating with an AP. Examples may include smartphones, laptop computers, portable gaming systems, specialized electronic devices for identifying APs, or any other such electronic device. Additional examples of mobile devices and computing devices may be disclosed in relationship to FIG. 6 below.

FIG. 1 illustrates one potential implementation of a network system 100 that may be implemented in an area where location services are to be deployed, and may be analyzed as part of an analysis of all APs in an area according to various embodiments. Network system 100 includes server computer 102, access points 112, 114, and 116, wireless local area network (WLAN) connectivity 110, and user computing devices 120, 122, and 124. In such a system, access points 112-116 may be coupled to server computer 102 and any other available infrastructure computing devices by wired or wireless connections. Access points 112-116 may then communicate with user computing devices 122 using WLAN connectivity 110.

Server computer 102 may comprise any computing device capable of processing location data and communicating with user computing devices 120-124 regarding location data. Server computer 102 may be located on site in an area for which assistance data is being provided, or may be located remotely. Server computer 102 may be dedicated to location services or providing assistance data to mobile devices, or may alternatively serve multiple functions in systems that also provide network connectivity to an extended network, such as the Internet. In such systems, user computing devices 120-124 may access Internet data via access points 112-116 via server computer 102 while simultaneously receiving assistance data from server computer 102.

FIG. 2 illustrates an aspect of a system that may be used in conjunction with the system described by FIG. 1. FIG. 2 illustrates an area over which a wireless network based positioning system may be deployed. FIG. 2 shows area 210 which encompasses locations 262, 264, 266, 268, 280, and 272. Access points 212, 214, 216, 218, and 220 may provide network connectivity for user's mobile devices as described above in FIG. 1.

Such access points may be associated with a particular location within the area. For example, if area 210 is a shopping mall operated by a first corporation, location 262 may be a first store within area 210 operated by a second and different corporation. Access point 212 may then be operated independently by the merchant with a store at location 262, while access points 216, 218, and 220 may be located within open areas of the shopping mall and operated by the first corporation that manages the mall.

In such a system, one party, such as the first corporation that operates the mall, may offer location services to users within the mall. Alternatively, parties may contract with an independent third party that may offer location services within area 210. A server computer such as server computer 102 that manages location services may thus be operated locally within area 210 or may be positioned remotely, with location data from user mobile devices and access points communicated to the server computer via a network. If the first corporation that operates the mall offers location services using a local server computer, individual merchants may be allowed to integrate their access points into the system to provide enhanced capabilities or to ensure adequate coverage within the merchant's location. For an individual system, then, certain access points may be coupled locally to a server computer managing network location services, and other access points may be coupled via a wider network connection such as through the Internet.

Additionally, access points as shown in FIG. 2 may be positioned to provide wireless network based location services over the entire surface of area 210, including over vertical locations if, for example, the area 210 includes multiple floors.

FIGS. 3a and 3b show an area 300 similar to area 210 of FIG. 2. As shown by FIGS. 3a and 3b, a large number of APs are deployed in area 300. Area 300 may be, for example, a mall with a large number of merchants operating in different locations in the mall. Location 310, for example, may be a small shop with a single merchant run AP 312. Location 330 may be a large chain store with a planned wireless network for location 330 that includes multiple APs, such as AP 332 and AP 334.

Additionally, APs 342a, 342b, 342c, 342d, and 342e may be part of a planned wireless deployment managed by a mall operator for use in public spaces or throughout area 300. Finally, additional APs 362 may comprise any number and quality of additional APs present in area 300 that may be accessed by a user with a mobile device from within area 300. APs 362 may be any type and sort of AP, operated by any operator. For example, some APs may simply be mobile devices placed in a mode where they function as temporary access points. In other circumstances, APs may be part of a planned permanent deployment of network connectivity. All of these and other types of APs may be part of APs 362.

FIG. 3b illustrates usage areas for APs 342. As shown in FIG. 3b, AP 342a may have a signal that is usable by a mobile device within area 343a. Similarly, APs 342b-e are shown as having associated areas. areas 343 may, for example, be associated with a received signal strength indicator (RSSI) map that indicates the edge where a signal from a particular access point becomes unusable. Each AP of FIG. 3a may have such an area associated with it, and RSSI map data may be part of assistance data. As may be seen from FIGS. 3a and 3b, if detailed RSSI map data is provided for each AP, a significant amount of overlapping data may be involved. Selecting a subset of the APs shown in FIG. 3a may provide significant efficiencies, and may be necessary for operation in environments where a total number of APs in an area can be in the hundreds.

A location such as area 300 of FIG. 3 may have significant overlap of APs and a wide variety of AP quality. If, for example, a scan of APs identified 675 unique media access control (MAC) addresses with a small number of known deployment APs, the amount of resources required to generate 675 heatmaps is excessive in terms of both time to create the maps and size of the data to be sent to a mobile device using location assistance data. If location assistance data was provided to a mobile device for all 675 MAC addresses, the amount of data would be excessive and would slow operation of the assistance system. Further, there is a high likelihood that at least a portion of these would be transient or mobile APs, and therefore not provide useful location information. Also, there is likelihood that many of these would not provide equivalent levels of information. Some, for example, may not provide stable round trip time (RTT) ranging information, or may not have RTT ranging functionality at all. Finally, some of these MACs may correspond to a single AP.

FIG. 4 illustrates one potential method of selecting a subset of access points from plurality of access points for assistance data generation. In S410, access points are identified in an area. This may be a densely provided area such that the number of APs and the overlap between APs create redundant and low value APs. In one potential example embodiment, APs may be identified by walking through the area with a specialized mobile device configured to identify and map APs, and receiving signals from every accessible AP within communication distance. Such a device may store identifying information for each AP for which a signal is received at the device. Such an identification method may be referred to as “warwalking.” Alternatively, AP operators may provide AP data to a database which may be accesses by a provider of location services during AP filtering.

Additionally, as part of S410, an identifier is associated with each access point. This may be an identifier created by a computing system implementing the method of selecting APs, or may be an identifier derived from a signal received from each AP such as a MAC address or other identifying information from an AP signal.

In S412, data collected for each AP may be analyzed to create a location assistance quality for each access point. In S414, a subset of the total identified APs is selected based on the location assistance quality for each AP. In certain embodiments, this may involve creating a table in a computer readable storage medium on a mobile device or in a server computer that is analyzing the quality of the APs. A location assistance quality value may be calculated from multiple quality metrics in the table. APs in the table above a certain quality threshold may then be selected. Alternately, a list with certain threshold requirements may be created in a computer memory, and APs may be deleted from the list as threshold requirements are not met.

In further embodiments, variable quality thresholds may be set based on the number of APs usable from given locations, such that for a map of an area like area 300, the best AP for sub-areas or specific locations are placed on the list, and all remaining APs are not selected. In still further alternative embodiments, a maximum number of allowable APs may be selected, and APs may be removed from the list based on coverage area and location assistance quality until an allowable number of APs remain to be selected for creation of assistance data. Finally, in S416, assistance data is generated for the subset of access points. Such assistance data may be generated by selecting from among previously generated data, or selected APs may be identified for additional data collection to be aggregated as assistance data at a later point in time.

FIG. 5 describes an additional alternative embodiment of a method for selection of APs. In S510, APs in an area are identified for an area where only a subset of the APs may be accommodated with assistance data. This may be done by retrieving known information about APs, or by communicating with APs directly to receive information from each AP.

In S512, identified APs are analyzed to determine any association with a vendor or a place name. AP MACs may be associated with vendors or place names, and certain vendors or place names may be assigned a higher priority based on history or expectations associated with APs provided by those vendors or operators. In S514, a name quality value may be assigned based on a name associated with an AP, and this name quality value may be part of a calculation for an overall assistance quality value. A wide range of customized information may be integrated with such name based priority. If a service set identification (SSID) of an AP contains a string similar to a venue name or company, it may be assigned a higher priority. Macy's™, for example, in an SSID received from an AP in a mall area may reasonably be expected to be a stable high quality signal associated with a store location. In certain embodiments, a dictionary of potential identifiers and name quality values associated with each potential identifier may be used with information about each AP. Trademarked names or well-known brand names may be provided high name quality values, and APs associated with such high name quality values may receive a high calculated assistance quality values.

Similarly in S516 if a particular name or identifier is seen repeatedly, or if variations on a particular name or identifier is seen repeatedly, a high name quality value may be assigned to APs associated with these identifiers. This high name quantity value may then be used as part of the calculation to create the overall location assistance quality value. Vendors or other providers with a large number of APs may thus receive additional priority, since it is likely that such APs a part of a planned deployment and will thus likely provide more useful and reliable location assistance data. An access point may thus have both an associated name quality value and a name quantity value, where the name quality value may associate a name with an expected performance of the access point based, for example, on a reputation of the name associated with the access point, and the name quality value is based on a frequency with which APs having the same or similar names are seen in a local area.

In S518, information indicating that an AP is a mobile device may be identified. Such information may be used to create a mobile quality value which may be used in calculating the overall assistance quality value. In certain embodiments this may be considered a threshold, and APs associated with mobile chips may be removed from consideration. For example, APs that are identified as operating from mobile side chips such as Novatel™ and Motorola Mobility™ may be removed from consideration, since they are likely to be mobile and/or transient, and are not likely to provide consistent assistance to users of a location service, and any associated assistance data would be unreliable.

In S520, MACs associated with a single AP may be merged into a single virtual AP with a standard set of location assistance data. Creating a single virtual AP may enable high quality APs to be included in the APs for which assistance data is created without duplicate redundant information for each MAC address. This may enable more efficient assistance to be provided as part of location services. In various alternative embodiments, two or more virtual APs may be created from multiple MACs associated with a single AP if the virtual APs have different assistance data.

In S522, AP signal quality may be analyzed and a signal quality value may be assigned to each AP. Signal quality may be based, for example, on horizontal dilution of precision and RSSI. APs in areas with good horizontal dilution of precision (HDOP) and sufficient APs within good RSSI range may not be as important as APs in areas with bad HDOP. Another method which may be used in alternative embodiments would be to ascertain how much the contribution of the specific AP is to the HDOP in its neighborhood but calculating the HDOP with and without the AP. The priority of the AP may be higher if its relative contribution to improving the HDOP is higher than its nearby neighbors. This requires spatial analysis using a generated heatmap. In certain embodiments, these steps may only be applied to a portion of the total number of APs in an area in order to reduce unnecessary data gathering. For example, the analysis and determinations of S512 through S520 may first be used to select a portion of the total number of APs for signal quality analysis, and the portion of the total number of APs may then be analyzed based on signal quality to further reduce the number of APs for which assistance data is to be generated and communicated to users.

In S524, the APs are selected based on the location assistance quality for each AP using the individual metrics in S512 through S522. Used in combination, the above sorting elements may allow selection of a reduced set of access points that provide a higher overall quality of location assistance data with a smaller amount of location assistance data. In addition, the capabilities of the mobile device can be a factor in the selection of the APs. For example, of the mobile device does not support a particular ranging method such as round trip time or angle of arrival, then those functionalities should not be considered in the selection of the APs in the assistance data.

In various embodiments, then, the generated assistance data may be used in multiple ways. In one potential embodiments, a third party analysis service may implement the method of FIG. 4 or 5, and may then provide the assistance data including identifiers for the selected highest quality APs to a local assistance service. In one embodiment, for example, the method of FIG. 5 may be implemented using a mobile device to identify a subset of APs, and the subset of APs may be provided to a local assistance server such as server computer 102 of FIG. 1. The assistance data including identifiers for the subset of APs and any additional assistance data may then be provided from server computer 102 to user computing devices 120, 122, and 124 when the devices are in the appropriate area.

In one potential embodiment, a name quality value, a name quantity value, a mobile quality value, and an number of other quality values related to area coverage or any other relevant quality may be added together to determine an overall location assistance quality value for each AP. In alternative embodiments, the values may be multiplied, or process through any determined function to arrive at a location assistance quality value for each AP. In still further embodiments, any combination of functions, minimum requirements, and/or thresholds may be used.

In further alternative embodiments, a remote server computer may access a database of stored data to identify and analyze APs in an area according to the method of FIG. 4. The server computer may then create the assistance data, and function as a remote assistance server in, for example, a Secure User Plane Location (SUPL) environment where a SUPL location platform (SLP) may make use of the assistance data to provide improved location and assistance services to users of mobile devices in an appropriate area.

In one potential alternative embodiment, the AP selection for a mobile device may be based on ranging capabilities of the particular mobile device. A system may thus request a set of capabilities from a mobile device, and filter criteria based on capabilities that the mobile device does not have. For example, if a mobile device cannot perform RTT measurements, then an RTT quality of an AP will be excluded from the filtering criteria. Similarly, any other criteria which may be used to filter APs but is dependent upon functionality existing in a mobile device, may be filtered out, creating separate filtering criteria in such embodiment depending on the functionality of different mobile devices.

FIG. 6 illustrates an example of a computing system in which one or more embodiments may be implemented. A computer system as illustrated in FIG. 6 may be incorporated as part of the previously described computerized devices. For example, computer system 600 can represent some of the components of the user mobile computing devices 120-124 and/or the server computer 102 discussed in this application. Computer system 600 may additionally represent any of the APs of FIG. 3. FIG. 6 provides a schematic illustration of one embodiment of a computer system 600 that can perform the methods provided by various other embodiments, as described herein, and/or can function as the host computer system, a remote kiosk/terminal, a point-of-sale device, a mobile device, and/or a computer system. FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include without limitation a mouse, a keyboard and/or the like; and one or more output devices 620, which can include without limitation a display device, a printer and/or the like.

The computer system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device and/or chipset (such as a Bluetooth™ device, an 802.11 device, a Wi-Fi device, a WiMax device, cellular communication facilities, etc.), and/or similar communication interfaces. A computing system may include one or more antennas for wireless communication as part of communications subsystems 630 or as a separate component coupled to any portion of the system. The communications subsystem 630 may permit data to be exchanged with a network (such as the network described below, to name one example), other computer systems, and/or any other devices described herein. In many embodiments, the computer system 600 will further comprise a non-transitory working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, an activity selection subsystem configured to provide some or all of the features described herein relating to the selection of activities by a context assistance server 140 can comprise hardware and/or software that is specialized (e.g., an application-specific integrated circuit (ASIC), a software method, etc.) or generic (e.g., processor(s) 610, applications 645, etc.) Further, connection to other computing devices such as network input/output devices may be employed.

Some embodiments may employ a computer system (such as the computer system 600) to perform methods in accordance with the disclosure. For example, some or all of the procedures of the described methods may be performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 625. Volatile media include, without limitation, dynamic memory, such as the working memory 635. Transmission media include, without limitation, coaxial cables, copper wire and fiber optics, including the wires that comprise the bus 605, as well as the various components of the communications subsystem 630 (and/or the media by which the communications subsystem 630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a non-transitory storage device 625 either before or after execution by the processor(s) 610.

FIG. 7 may then describe a particular embodiment of a mobile device such as user computing devices 120, 122, and 124 of FIG. 1. Mobile device 700 includes a processor 710, and a memory 720. Mobile device 700 may use processor 710 configured to execute instructions for performing operations at a number of components and can be, for example, a general-purpose processor or microprocessor suitable for implementation within a portable electronic device. Processor 710 is communicatively coupled with a plurality of components within mobile device 700. To realize this communicative coupling, processor 710 may communicate with the other illustrated components across a bus 740. Bus 740 can be any subsystem adapted to transfer data within mobile device 700. Bus 740 can be a plurality of computer buses and include additional circuitry to transfer data.

Memory 720 may be coupled to processor 710. In some embodiments, memory 720 offers both short-term and long-term storage and may in fact be divided into several units. Memory 720 may be volatile, such as static random access memory (SRAM) and/or dynamic random access memory (DRAM) and/or non-volatile, such as read-only memory (ROM), flash memory, and the like. Furthermore, memory 720 can include removable storage devices, such as secure digital (SD) cards. Thus, memory 720 provides storage of computer readable instructions, data structures, program modules, and other data for mobile device 700. In some embodiments, memory 720 may be distributed into different hardware modules.

In some embodiments, memory 720 stores a plurality of application modules 721 through 722, which may be any number of applications. Application modules contain particular instructions to be executed by processor 710. In alternative embodiments, other hardware modules 701 may additionally execute certain applications or parts of applications 721-722. In certain embodiments, memory 720 may additionally include secure memory, which may include additional security controls to prevent copying or other unauthorized access to secure information.

In some embodiments, memory 720 includes an operating system 723. Operating system 723 may be operable to initiate the execution of the instructions provided by application modules 721-722 and/or manage other hardware modules 701 as well as interfaces with communication modules which may use wireless transceiver 712. Operating system 723 may be adapted to perform other operations across the components of mobile device 700 including threading, resource management, data storage control and other similar functionality.

In some embodiments, mobile device 700 includes a plurality of other hardware modules 701. Each of other hardware modules 701 is a physical module within mobile device 700. However, while each of hardware modules 701 is permanently configured as a structure, a respective one of hardware modules 701-702 may be temporarily configured to perform specific functions or temporarily activated. A common example is an application module that may program a camera module (i.e., hardware module) for shutter release and image capture. A respective one of hardware modules 701 can be, for example, an accelerometer, a Wi-Fi transceiver, a satellite navigation system receiver (e.g., a GPS module), a pressure module, a temperature module, an audio output and/or input module (e.g., a microphone), a camera module, a proximity sensor, an alternate line service (ALS) module, a capacitive touch sensor, a near field communication (NFC) module, a Bluetooth transceiver, a cellular transceiver, a magnetometer, a gyroscope, an inertial sensor (e.g., a module the combines an accelerometer and a gyroscope), an ambient light sensor, a relative humidity sensor, or any other similar module operable to provide sensory output and/or receive sensory input. In some embodiments, one or more functions of the hardware modules 701-702 may be implemented in software.

Mobile device 700 may include a component such as wireless communication module which may integrate antenna 714 and wireless transceiver 712 with any other hardware, firmware, or software necessary for wireless communications. Such a wireless communication module may be configured to receive signals from various devices such data sources via networks and access points such as network access point 120.

In addition to other hardware modules 701 and application modules 721-722, mobile device 700 may have a display module 703 and a user input module 704. Display module 703 graphically presents information from mobile device 700 to the user. This information may be derived from one or more application modules 721, one or more hardware modules 701, a combination thereof, or any other suitable means for resolving graphical content for the user (e.g., by operating system 723). Display module 703 can be liquid crystal display (LCD) technology, light emitting polymer display (LPD) technology, or some other display technology. In some embodiments, display module 703 is a capacitive or resistive touch screen and may be sensitive to haptic and/or tactile contact with a user. In such embodiments, the display module 703 can comprise a multi-touch-sensitive display.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method comprising:
identifying, using a computing device, a plurality of access points in a first area using an identifier for each access point of the plurality of access points;
associating a location assistance quality value with each access point of the plurality of access points;
selecting a subset of the plurality of access points based on the location assistance quality value of each access point of the plurality of access points; and
generating assistance data including identifiers for the subset of the plurality of access points.

2. The method of claim 1 further comprising:
communicating the assistance data for the subset of the plurality of access points to a mobile device in response to a request for location services.

3. The method of claim 1 wherein the location assistance quality value comprises a first quality value based on previously determined vendor priority.

4. The method of claim 1 wherein the location assistance quality value comprises a second quality value based on a number of access points associated with a particular vendor.

5. The method of claim 1 wherein the location assistance quality value comprises a value associated with a mobile side chip.

6. The method of claim 1 wherein the location assistance quality value comprises a horizontal dilution of precision (HDOP) value.

7. The method of claim 1 wherein the location assistance quality value comprises a received signal strength indication (RSSI) heat map quality value.

8. The method of claim 1 further comprising, calculating the location assistance quality value using a name quality value, a name quantity value, and a mobile quality value.

9. The method of claim 8 wherein calculating the location assistance quality value further comprises:
determining a first group of access points from the name quality value, the name quantity value, and the mobile quality value of each of the plurality of access points to identify the first group of access points;
receiving horizontal dilution of precision (HDOP) information and received signal strength indication (RSSI) heat map information for each access point of the first group of access points;
calculating a signal quality value from the HDOP information and the RSSI heat map information; and
further calculating the location assistance quality value using the signal quality value.

10. The method of claim 1 wherein selecting the subset of the plurality of access points based on the location assistance quality value of each access point of the plurality of access points comprises eliminating access points identified as having mobile chipsets from the subset of the plurality of access points.

11. The method of claim 1 further comprising communicating the assistance data to a location assistance server.

12. The method of claim 1 wherein identifying the plurality of access points in the first area using the identifier for each access point of the plurality of access points comprises:
receiving, using a mobile device comprising the computing device at a first location within the first area, a first set of signals from at least a first portion of the plurality of access points;
receiving, using the mobile device at a second location within the first area, a second set of signals from at least a second portion of the plurality of access points; and
associating a first set of identifiers corresponding to the identifier for each access point of the plurality of access points with each access point of the first and second portions of the plurality of access points.

13. The method of claim 1 wherein identifying the plurality of access points in the first area using the identifier for each access point of the plurality of access points comprises:
identifying a plurality of media access controls (MACs) associated with a single access point;
merging the plurality of MACs associated with the single access point into a virtual access point; and
assigning a first identifier to the virtual access point.

14. The method of claim 13 wherein associating the location assistance quality value with each access point of the plurality of access points comprises associating a first location assistance quality value with the virtual access point.

15. A mobile device comprising:
a processor;
an antenna coupled to the processor; and
a computer readable storage device coupled to the processor;
wherein the antenna receives signals from a plurality of access points and communicates the signals to the processor which identifies the plurality of access points in a first area using an identifier for each access point of the plurality of access points; and
wherein the processor associates a location assistance quality value with each access point of the plurality of access points, selects a subset of the plurality of access points based on the location assistance quality value of each access point of the plurality of access points and generates assistance data including identifiers for the subset of the plurality of access points.

16. The mobile device of claim 15 wherein the processor further communicates the assistance data to a location assistance server via the antenna.

17. The mobile device of claim 15 wherein the processor further calculates RSSI map data using the signals from the plurality of access points, and wherein the location assistance quality value of each access point of the plurality of access points is based on the RSSI map data.

18. A non-transitory computer readable storage medium comprising a computer program product of computer readable instructions for performing a method of providing assistance data, the method comprising:
receiving, at a computing device, at least one signal associated with a plurality of access points in a first area;
identifying the plurality of access points using an identifier for each access point of the plurality of access points;
associating a location assistance quality value with the identifier for each access point of the plurality of access points;
selecting a subset of the plurality of access points based on the location assistance quality value of each access point of the plurality of access points; and
generating the assistance data including identifiers for the subset of the plurality of access points.

19. The non-transitory computer readable storage medium of claim 18 wherein the computing device comprises a location assistance server, and wherein the at least one signal is received from a first mobile device in communication with at least a portion of the plurality of access points.

20. The non-transitory computer readable storage medium of claim 19 wherein the method further comprises:
receiving, from a second mobile device, a request for the assistance data associated with the first area; and
communicating from the computing device to the second mobile device, the assistance data including the identifiers for the subset of the plurality of access points.

21. A computing device comprising:
means for identifying a plurality of access points in a first area using an identifier for each access point of the plurality of access points;
means for associating a location assistance quality value with each access point of the plurality of access points;
means for selecting a subset of the plurality of access points based on the location assistance quality value of each access point of the plurality of access points; and
means for generating assistance data including identifiers for the subset of the plurality of access points.

22. The device of claim 21 further comprising:
means for communicating the assistance data for the subset of the plurality of access points to a mobile device in response to a request for location services.

23. The device of claim 21 further comprising:
means for calculating the location assistance quality value using a name quality value, a name quantity value, and a mobile quality value.

24. The device of claim 21 further comprising:
means for determining a first group of access points from the name quality value, the name quantity value, and the mobile quality value of each of the plurality of access points to identify the first group of access points;
means for receiving horizontal dilution of precision (HDOP) information and received signal strength indication (RSSI) heat map information for each access point of the first group of access points;
means for calculating a signal quality value from the HDOP information and the RSSI heat map information; and
means for calculating the location assistance quality value using the signal quality value.
